(19) United States
(12) Patent Application Publication
(10) Pub. No.: US 2020/0378727 A1
(43) Pub. Date: Dec. 3, 2020

(54) TRANSPARENT ARMOR POTTING DESIGN FOR ENHANCED DELAMINATION RESISTANCE

(71) Applicant: Ibis Tek, Inc., Butler, PA (US)

(72) Inventor: David Puckett, Easton, MD (US)

(21) Appl. No.: 16/891,792

(22) Filed: Jun. 3, 2020

Related U.S. Application Data
(60) Provisional application No. 62/856,291, filed on Jun. 3, 2019.

(51) Int. Cl. F41H 5/04; B32B 7/12; B32B 17/06; B32B 18/00; B32B 27/06; B32B 27/36; B60J 1/20

(52) U.S. Cl. CPC F41H 5/0407; F41H 5/0414; B32B 7/12; B32B 17/064; B32B 18/00; B32B 2605/006; B32B 27/365; B60J 1/2094; B32B 2571/02; B32B 2307/558; B32B 27/06

(57) ABSTRACT

Methods of making improved framed transparent armor product are provided. The product having a compressive element; a high flow adhesive-sealant elastomeric material; a frame and a multilayer transparent armor (TA) laminate. The frame and TA laminate being about the same depth, the frame being larger than the TA in length and width thereby defining a potting gap between the interior of the frame and the outer edges of the TA when the TA is placed inside the frame. The compressive element is located with the potting gap at the site of any layer of the TA that may undergo expansion.

### BACKGROUND

Transparent armor (TA) resists the penetration of projectiles such as bullets and explosively driven fragments while also allowing transmission of light. Most commonly, TA is designed to transmit in visible and near infra-red wavelengths to accommodate human vision and vision enhancement devices such as night vision goggles and sensors.

TA is commonly produced by lamination of one or more layers of a hard, strong and transparent material such as glass, ceramized glass, or transparent ceramic with one or more backing layers of transparent material that are tough, strong, and resistant to cracking. The initial hard layers resist penetration by deforming the projectile and distributing kinetic energy. Typically, the initial layers are fractured by the projectile impact. If not contained, the fractured materials can be accelerated by impact forces to become hazardous secondary projectiles referred to as spall. The tough, strong and crack resistant transparent backing layers are employed to provide the containment needed to suppress spall. Collectively, the several layers of the transparent armor are referred to as a laminate.

The combination of dissimilar materials in a TA laminate produces several adhesion challenges that must be met to provide long-term durability. For example, glass and plastic transparent backing layers exhibit widely different coefficients of thermal expansion (CTE), often differing by a factor of 10 or more. As a result, the differential expansion and contraction of adjacent layers during temperature changes produces strong interlaminar shear and peeling forces that stress the interlayer adhesive bonds. In some cases, these forces exceed the available bonding strength and delamination results. This is especially true around the laminate edges where maximum bond stress occurs and interlayer adhesion is vulnerable to weakening by exposure to moisture and resultant hydrolysis.

When TA is employed on a vehicle or structure, it is usually sealed and bonded in a protective frame that provides a means of secure mounting. The sealing and bonding process and associated materials are referred to as “potting”. Historically, the choice of materials and design of the potting system has not addressed this problem. As a result, TA that is potted with a solid elastomeric material can experience high compressive stress at the edge of the plastic transparent backing layer which leads to delamination and shortened service life. At present, delamination of military transparent armor is a significant problem that requires millions of dollars to be spent every year to reacquire replacement armored windows. The designs described herein provide longer lasting and more delamination resistant windows. cl SUMMARY

A product that improves the delamination resistance of TA is provided. The product having a compressive element, an adhesive-sealant elastomeric material, a frame, and a multilayer transparent armor (TA) laminate. In the product, the frame and TA laminate are about the same depth, the frame is larger than the TA in length and width thereby defining a potting gap between the interior of the frame and the outer edges of the TA when the TA is placed inside the frame. The potting gap may be about 1 to 20 millimeters. The compressive element is placed in the potting gap between the frame and TA. The compressive element either is secured to the frame, the TA, or may be surrounded by the adhesive-sealant elastomeric material that fills the potting gap.

The compressive element of the product will possess a principally closed-cell foam structure to avoid moisture collection and provide compressibility. The element may generally have a height of at least the thickness of a transparent backing material layer of the TA and be identical in thickness to the potting gap or less than the potting gap. The compressive element will extend around the entire periphery of the TA and may be any material that will accommodate expansion of a layer of the TA laminate thereby reducing stress on the laminate edge and the cured adhesive-sealant elastomeric material that is in the potting gap and secures the TA to the frame. Alternately, the compressive element may be provided by the use of a foam-forming elastomeric potting material that simultaneously provides sealing and bonding of the TA to the frame while also providing the necessary compressibility.

The adhesive-sealant elastomeric material and compressive material may be a homogeneous mixture or the adhesive-sealant elastomeric material may be a two component reaction cured urethane containing no solvents having a cured property of between about 35 to about 90 on the Shore A scale and a Poisson's Ratio between 0.48 and 0.5.

The frame may be steel, aluminum or a fiber composite material. The frame has first (inner) flange on which the TA laminate rests and a second (exterior) flange that comprises means for securing the TA laminate/frame material into a vehicle, building or other location.

The multilayer transparent armor (TA) laminate may include at least one layer of glass, ceramized glass, or transparent ceramic; at least one or more transparent backing layer of transparent material; and transparent adhesive joining the layers to each other. The coefficients of thermal expansions of the glass and the transparent material may be different.

The product may further include a spacer secured to the housing or frame upon which the multilayer transparent armor (TA) laminate rests.

A method of making the framed transparent armor (TA) product includes steps of providing a frame and multilayer transparent armor (TA) laminate that fits within the frame and defines a potting gap between the interior of the frame and the outer edges of the TA; placing spacers on the first frame flange; adding a compressive element; placing the TA within the frame and directly upon the spacers; sealing the junction between the TA laminate and the first frame flange; applying a potting product to the potting gap.

In the method of making a framed transparent armor, there may be provided means of securing the spacer or compressive material to either the frame or TA laminate. The compressive element may be secured to the interior of the frame at a position aligned with a transparent material layer of the TA laminate, or the compressive material applied around the entire outer edge of the TA laminate corresponding to a transparent material layer.

### BRIEF DESCRIPTION OF THE DRAWINGS

The novel features of the invention are set forth with particularity in the appended claims. A better understanding of the features and advantages of the present invention may be obtained by reference to the following detailed description that sets forth illustrative aspects in which the principles of the invention are utilized, and the accompanying drawings of which:

FIG. 1A-D are perspective views of a multilayer transparent armor (TA) laminate, frame, and potting material of the invention.

FIG. 1A depicts a perspective view of the multilayer transparent armor (TA) laminate and frame.

FIG. 1B depicts a top view and FIG. 1C a side view of the assembled product of multilayer transparent armor (TA) laminate in frame and secured with potting material.

FIG. 1D is an exploded side view of the assembled TA, frame and potting material along line A-A.

FIG. 2A-C depicts top (FIG. 2A), side (FIG. 2B), and exploded side views (FIG. 2C) along line B-B of a frame.

FIG. 3A-B depict exploded side views of two means for securing a TA to a frame.

FIG. 4A-B depict exploded side views of expansion of the transparent backing layer of a TA at rest (FIG. 4A) and in response to heat (FIG. 4B).

FIG. 5A-B depict exploded side views of expansion of the transparent backing layer in two configurations, the transparent backing layer being closest to the first (inner) frame flange (FIG. 5A) and alternatively closest to the external frame flange (FIG. 5B).

FIG. 6A-B depict exploded side views of expansion of the transparent backing layer of a TA with a compressive element added to the potting material at rest (FIG. 6A) and in response to heat (FIG. 6B).

FIG. 7A-C depict exploded side views of different locations of the compressive material. The compressive material may be surrounded by potting material (FIG. 7A), secured to the frame (FIG. 7B) or secured to the transparent backing layer of the TA (FIG. 7C).

FIG. 8 depicts exploded side view of an aspect of the invention.

FIG. 9 depicts exploded side view of an aspect of the invention.

FIG. 10 depicts an exploded side view of an aspect of the invention.

FIG. 11 depicts observation timeline for onset and growth of delamination for control samples numbered 1-11 and samples prepared according to an aspect of the invention numbered 12-14.

FIG. 12 depicts a plot of delamination extent vs. time for control window samples and samples of windows prepared according to an aspect of the invention.

### DETAILED DESCRIPTION

To improve the durability of framed transparent armor a new product will now be described in detail. A product comprising: a compressive element; a high flow adhesive-sealant elastomeric material; a frame having an first (inner) frame flange, an external frame flange, means for mechanical attachment of the housing to a secondary structure on the external frame flange; and a multilayer transparent armor (TA) laminate, the frame and TA laminate being about the same depth, the frame being larger than the TA in length and width thereby defining a potting gap between the interior of the frame and the outer edges of the TA when the TA is placed inside the frame.

The compressive element of the product may have a closed cell structure to avoid moisture collection and may be a material selected from the group consisting of: silicone rubber, polyvinyl chloride (PVC), ethylene propylene diene monomer (EPDM), urethane, neoprene, natural rubber, ionomer, polyethylene, nylon, a fluoro-elastomer (FKM) polymer, synthetic rubber, or a fluoropolymer, such as for example, Viton®, a long-chain fiber-forming polyamide or a synthetic polymer of an aliphatic or semi-aromatic polyamine, such as for example Nylon®, and a thermoplastic vulcanizate (TPV) or a thermoplastic elastomer (TPE), such as, for example, Santoprene®, or any similar material of a closed cell foam-like structure that offers compressive and tensile elasticity while also chemically compatible with the selected potting materials and suitable for use in a temperature range from approximately −30° C. to +60° C. with temporary exposure to temperatures as low as −60° C. and as high as +90° C. Generally, the compressive element may have a length of at least the size of a transparent material layer of the TA and be identical in width to the potting gap or less than the potting gap.

The adhesive-sealant elastomeric material and compressive material may be a homogeneous mixture.

The adhesive-sealant elastomeric material may be a two component reaction cured urethane containing no solvents. The sealant material may have a cured property of between about 35 to about 90 on the Shore A scale and a Poisson's Ratio between 0.47 and 0.5, between about 0.47 and about 0.5, between 0.48 and 0.5, between about 0.48 and about 0.5, between 0.49 and 0.5, between about 0.49 and about 0.5; or 0.47, 0.48, 0.49, 0.50 or any individual number between 0.47 and 0.5 such as 0.475, 0.492 or the like. Similarly, the sealant material may have a cured property of any number between about 35 and 90, such as for example 37 or 89.

The frame may be steel, aluminum or a fiber composite material.

The multilayer transparent armor (TA) laminate may comprise: at least one layer of glass, ceramized glass, or transparent ceramic; at least one or more transparent backing layer of transparent material; and transparent adhesive joining the layers to each other. The transparent armor may comprise materials being polycarbonate or poly(methyl methacrylate), polyamide, polyethylene terephthalate or ionoplast. The transparent armor adhesive may be polyvinyl butyral, thermoplastic polyurethane, ionoplast, ethylene-vinyl acetate or various UV curing optically clear adhesive (OCA) materials. The coefficients of thermal expansions of the glass and the transparent material differing from each other by a factor of about 10 or more.

The product may further comprise a spacer secured to the housing upon which the multilayer transparent armor (TA) laminate rests.

The potting gap of the product may be between about 1 millimeter and about 20 millimeters.

A method of making framed Transparent Armor (TA) product will now be described in detail The method comprises: providing a housing frame having first (inner)frame flange, a second (exterior) frame flange, means for mechanical attachment of the housing to a secondary structure on the external frame flange; providing a multilayer transparent armor (TA) laminate, the housing and TA laminate being about the same depth, the housing being larger than the TA in length and width thereby defining a potting gap between the interior of the frame and the outer edges of the TA; placing spacers on the first (inner) frame flange; adding a compressive element; placing the TA within the frame and directly upon the spacers; sealing the junction between the TA laminate and the first (inner) frame flange; applying a potting product to the potting gap.

The method of making a framed transparent armor may also comprise means of securing the spacer or compressive material to either the frame or TA laminate.

In the method, the compressive element may be secured to the interior of the frame at a position aligned with a transparent material layer of the TA laminate, or the compressive material applied around the entire outer edge of the TA laminate corresponding to a transparent material layer. In general, the compressive element may be secured to the TA laminate in the path of greatest thermal expansion of the transparent material layer.

The compressive element may be placed in the potting gap between the frame and TA and surrounded by potting material. The thickness of the compressive element may be identical to the potting gap or less than the potting gap. The compressive element and potting product may be a homogeneous mixture.

The compressive element of the method may be a material selected from the group consisting of: silicone rubber, polyvinyl chloride (PVC), ethylene propylene diene monomer (EPDM), urethane, neoprene, natural rubber, ionomer, polyethylene, nylon, fluoro-elastomer (Viton®), polyamine (Nylon®), thermoplastic vulcanization (Santoprene®) or any similar material of a closed cell foam-like structure that offers compressive and tensile elasticity while also chemically compatible with the selected potting materials and suitable for use in a temperature range from approximately −30° C. to +60° C. with temporary exposure to temperatures as low as −60° C. and as high as +90° C.

The potting product of the method may be a two component reaction cured urethane containing no solvents. The potting product may have a cured property of between 35 to 90 on the Shore A scale and a Poisson's Ratio between 0.47 and 0.5.

The frame of the method may be steel, aluminum or a fiber composite material. The multilayer transparent armor (TA) laminate of the method may be comprised of: at least one layer of glass, ceramized glass, or transparent ceramic; at least one or more transparent backing layer of transparent material; and transparent adhesive joining the layers to each other. The transparent materials of the TA laminate may be polycarbonate or poly(methyl methacrylate). The transparent armor adhesive may be polyvinyl butyral, thermoplastic polyurethane, ionoplast, ethylene-vinyl acetate or various UV curing optically clear adhesive (OCA) materials. The coefficients of thermal expansions of the glass and the transparent material of the TA laminate differ from each other by a factor of about 10 or more.

The potting gap being between about 1 millimeter and about 20 millimeters.

Also described is a framed TA produced by the method as described above.

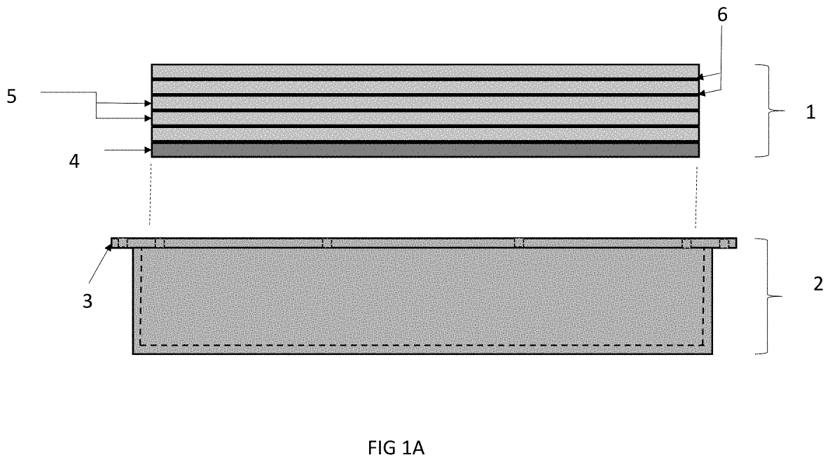

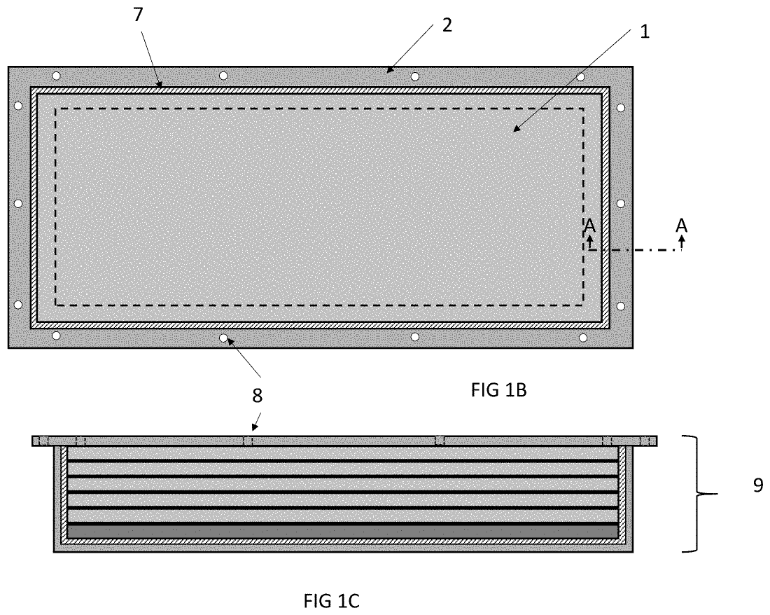

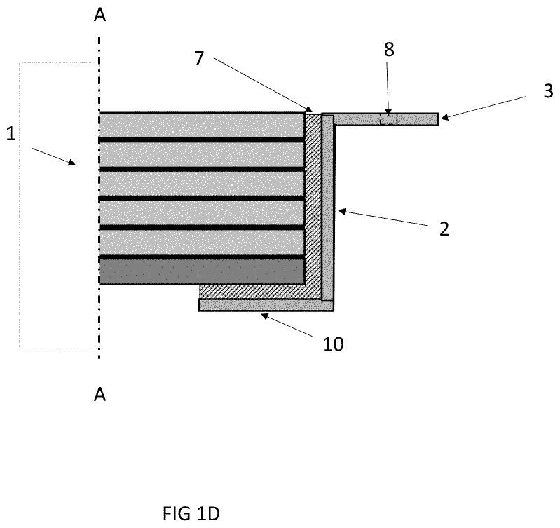

FIG. 1A depicts the multilayer transparent armor (TA) laminate 1 and frame 2 of the invention. In particular, the dotted line between the TA and frame indicates that the TA fits within the frame; dotted lines on the frame indicate how TA sits within frame from a side view. The TA and frame are of approximately the same height. The frame is larger in length and width so as to fit the TA within the frame. The frame has an outer flange 3.

The TA comprises three kinds of layers. At least one transparent backing layer, 4 and multiple glass or other transparent material layers 5, and adhesion layers 6. The hard glass layers and tough plastic layers comprise a synergistic protection system. The layers must be joined in a manner that allows light transmission with a minimum of absorption and scattering. Usually, joining is accomplished by use of a transparent adhesive, typically polyvinyl butyral (PVB), thermoplastic polyurethane (TPU), or ethylene-vinyl acetate (EVA), among others, that provide a close match to the index of refraction of the adjoined layers. These adhesive layers are often referred to as “interlayers”. A highly transparent multi-layer laminate is thus produced. As presented in the Figures, the TA may include multiple layers of glass adjacent to each other and adhered to a plastic backing layer. It will be appreciated that other configurations of TA are usable in the products and methods described herein. For example, the plastic backing layer maybe interspersed between glass layers, or more than one layer of plastic backing may be used. One, two, three or more layers of glass of any thickness may be used. Likewise, the TA is not limited by thickness of any of the plastic backing, glass or adhesion layer.

FIG. 1B depicts a top view and FIG. 1C side view of the assembled product. FIG. 1D depicts an exploded side view along line A-A of the assembled product. The multilayer transparent armor (TA) laminate 1 placed in frame 2 and secured with potting material 7.

The frame 2 has an external flange 3. The external flange comprises means for mechanical attachment 8, such as bolt accommodating holes that are useable to mount and secure the framed TA product to a building, vehicle, ship, aircraft, shield, barricade, sensor housing, or other device. The frame may also have an interior flange 10 that provides a surface along the perimeter of the frame for the TA to be placed.

Adhesive-sealant materials often referred to as “potting” material, 7 is applied to the potting gap between the frame and TA.

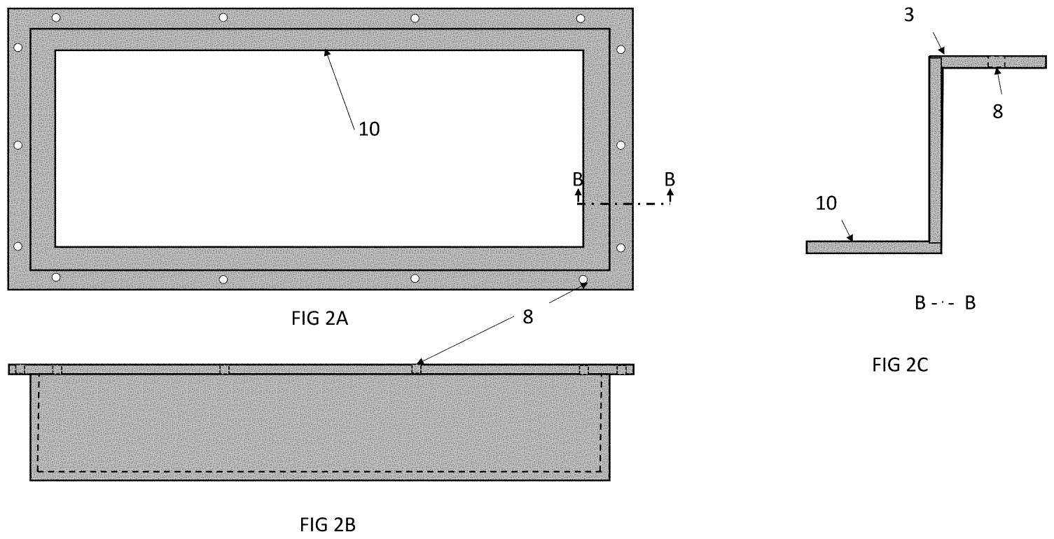

The frame is further described in FIG. 2 which depicts top (FIG. 2A), side (FIG. 2B), an exploded side view (FIG. 2C) along line B-B of a frame. The frame fulfills several functions including provisions for mechanical attachment 8, for example, by bolts. The frame also provides protection of the TA laminate from incidental damage during handling and while in service, and environmental protection against degradation from UV light and moisture. Framing systems may be made from steel, aluminum or fiber-composite materials and are designed to provide durability and sufficient strength and rigidity to securely mount and retain the transparent armor laminate, which typically weighs between 50 and 200 lbs. The first (inner) or interior flange and the external flange may be of any size and may be the same or different material from the body of the frame; the frame may be a single article of manufacture or the flanges may be added to the body of frame by means.

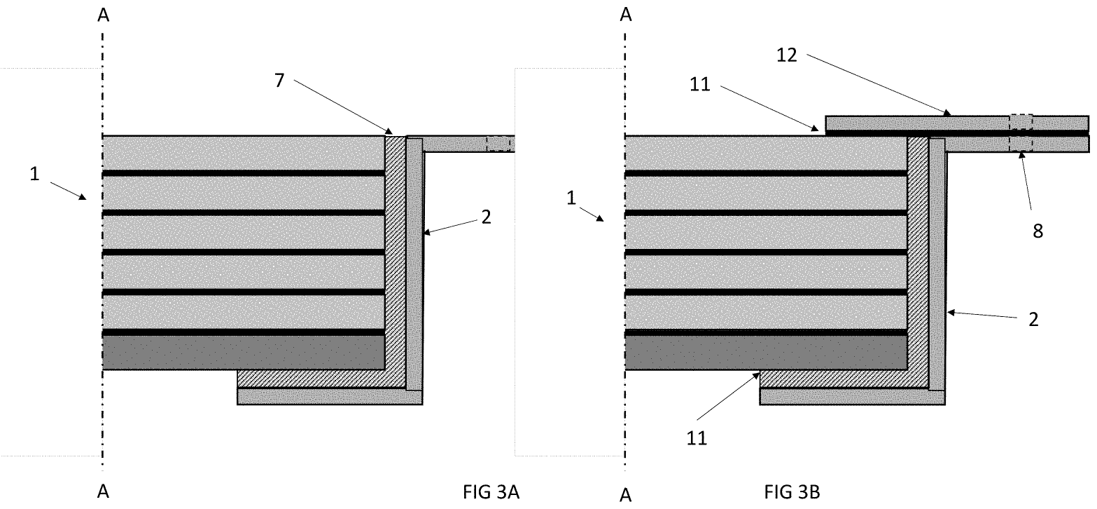

FIG. 3A-B depict two scenarios for securing a TA 1 to a frame 2. In FIG. 3A, the TA 1 is secured to a frame 2 with adhesive-sealant potting material 7. In FIG. 3B, in addition to the potting material, an additional frame element 12 is secured to the TA/frame assembly by bolts (not shown) to provide a clamping arrangement to positively retain the TA laminate. In FIG. 3B, gaskets 11 are provided to further seal the TA/frame junction.

A suitable potting material is selected based on environmental durability requirements and sealing capability for the surfaces to be joined. Typically, one surface would be the frame material such as steel, aluminum, plastic, or composite, or it may be a coating such as CARC paint, as used in most military applications, which has been applied to the frame. A second surface would be the edge of the TA laminate comprising glass and plastic materials together with some interlayer adhesive that is exposed along the laminate interfaces. The potting must be compatible with these surfaces in terms of both adhesion and chemical characteristics so that long term durability is achieved.

TA potting must satisfy several additional requirements. First, it must prevent the ingress of water or water vapor since many interlayer materials used to bond the layers of TA can be degraded by hydrolytic processes, which leads to loss of bond strength and subsequent delamination. Second, it must provide adhesive strength to retain the laminate within its frame. Often, the only means of retention of the TA laminate within its frame is the adhesive strength of the potting material. Additionally, the potting must provide a degree of vibration damping and isolation between frame and laminate so high mechanical damping coefficients are beneficial. Prior to cure, the potting also should exhibit sufficiently low viscosity to flow into gaps of only a few millimeters while displacing and releasing air bubbles. Single component sealants, such as moisture cure urethanes, are commonly used for potting but are not well suited due to their thick, low-flow, caulk-like viscosity. As a result, air pockets are easily trapped which weaken the bond, provide cavities in which moisture can collect, and reduce overall sealing effectiveness. Additionally, once the outer regions (closest to air exposure) of the moisture-cure sealant have cured, the remaining volume of sealant trapped deep within the potting gap is unable to receive the moisture it requires for proper curing. It becomes sealed within the frame much like the material was sealed within its original packaging where it does not cure because no moisture is available to it. Consequently, a common problem noted with this type of potting is water penetration and collection as well as weak/partially cured bonds.

To address these shortcomings, two-component reaction cured and accelerated moisture-cure two-component potting materials with high flow (low viscosity) have been employed. A variety of urethane based sealant-adhesives of this type are available that offer excellent environmental durability and perform well under extremes of temperature and humidity. This type of elastomer-sealant is usually delivered to the potting gap through use of automatic meter/mix/dispense equipment that provides an on-demand supply of material via a triggered dispense nozzle.

Two component potting materials cure by chemical reaction that cross-link polymer chains and consequently do not rely on exposure to air or atmospheric moisture, so full curing in deep potting gaps is assured provided the components of the sealant are mixed adequately and with the proper ratio. Potting materials containing no solvents (100% solids) are suitable since there is no off-gassing during cure and usually very little cure shrinkage. Final properties of urethanes are highly tailorable with typical durometer (hardness) ranging from about 35 to about 90 on the Shore A scale although values beyond this range are possible. Urethanes with cured hardness near Shore A 70, similar to automotive tire rubber, have been used. Some silicone and epoxy-based materials offer similar qualities.

However, homogeneous elastomeric materials that are otherwise suitable for potting will generally exhibit high bulk moduli resulting from characteristic Poisson's Ratio values in the range of about to nearly about 0.50. These high Poisson's values produce extremely low compressibility, even across a wide range of elastic moduli, and this presents special problems when used as potting for transparent armor.

The problems arise from the incompressibility of the potting material when confined within a rigid walled container, like the potting gap between TA and frame. This gap may be open on one or both edges however the slender geometry of the gap and the rigidity of the frame and TA materials that define the gap cause the bulk of the potting material to behave as an incompressible solid. To the extent that some free space is available into which the elastomer can distort (in response to an applied load), some deformation is possible, even with high bulk modulus materials. However, within the confines of the potting gap, no space exists for distortion resulting in high compressive rigidity (FIG. 3A-B).

For TA potting, compressive rigidity would not necessarily present problems if the frame and laminate were to remain at constant conditions. It is expected that the framed TA will be subjected to many different stresses, including temperature changes, heating and cooling cycles, UV and weather exposure, changes in pressure. Taking temperature as an example, the difficulty begins when temperature changes occur, especially temperature increases, which result in differential thermal expansion of the various materials comprising the system.

This is particularly acute with respect to the plastic transparent backing layer that expands much more than the glass to which it is bonded. This could lead to a condition where compressive stress is developed around the edge of the TA laminate as it pushes outward against the confining strength of the frame. In most cases, TA frames are made from aluminum or steel alloys that are characterized by coefficients of thermal expansion (CTE) values somewhat larger than that of glass. The frame will typically expand more than glass in response to heating and compressive stresses on the glass layers are avoided.

The CTE of the potting material should also be considered. Typically, urethane potting will exhibit a linear CTE around 10x that of glass, but since potting gaps are relatively thin compared with the length dimensions of the glass and frame, this expansion difference does not produce much edge pressure on the TA laminate.

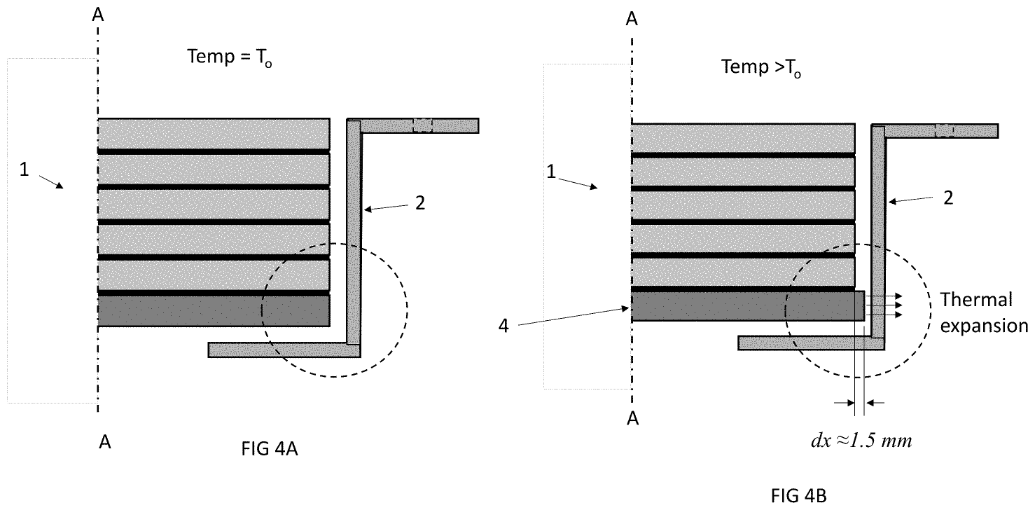

In contrast to the low expansion loading at the glass edges, the edge load generated at the plastic transparent backing of the TA laminate can become extremely large. This results from the length of the plastic transparent backing layer itself, which extends entirely across the surface of the TA, and the large CTE difference that exists between glass, frame materials, and the plastic layer. For example, a typical TA windshield is approximately one meter in length. When heated by 50° C., the difference in length between glass and plastic transparent backing approaches a total of 3 mm in width and height as shown in FIG. 4B. FIG. 4A depicts an exploded view of TA laminate 1 in frame 2 at base temperature. FIG. 4B depicts thermal expansion of the plastic transparent backing 4 of the TA 1 as temperature is increased. In FIG. 4A-B, the potting is omitted for clarity. The dashed circle in FIG. 4A-B highlights the area of expansion of the transparent backing layer within the frame.

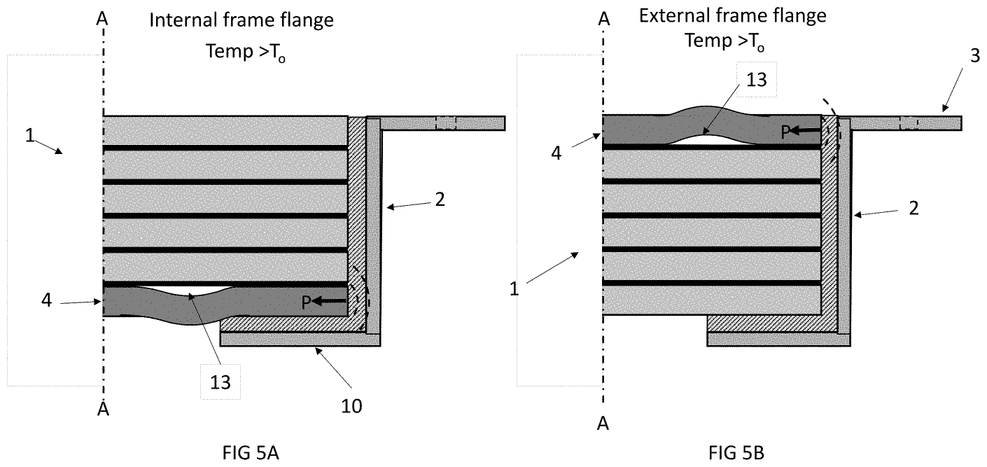

When rigidly confined in the loading direction, the load (P) developed due to this expansion approaches 900 N, or about 2000 lbf (pound force) for a window that is 0.4 meters in height (FIG. 5A-B). When the expansion of a steel frame is taken into account, the edge load drops by about 25%, but in either case it remains well beyond the buckling strength of the plastic transparent backing layer if it were not bonded to the glass. The only source of counter force acting to maintain the planarity of the plastic transparent backing layer is derived from the strength of the interlayer adhesive bond.

As a result, large shear and peel stresses are generated in the bond as the strength of adhesion works to prevent buckling of the plastic transparent backing. Research has shown that, over time, this thermally induced edge stress leads to the eventual failure of the bond and delamination between the glass and plastic transparent backing results. If the thermal expansion stress is reapplied, or if it is cyclically applied as in the case of daily heating and cooling cycles occurring in nature, this delamination can be caused to spread progressively across the surface of the TA window leading to total service failure for the armor.

FIG. 5A and 5B demonstrate delamination 13 of the transparent backing layer 4 from compressive buckling regardless of how the TA is fit in the frame. In FIG. 5A, the transparent backing layer 4 being closest to the first (inner) frame flange and alternatively in FIG. 5B being closest to the external frame flange.

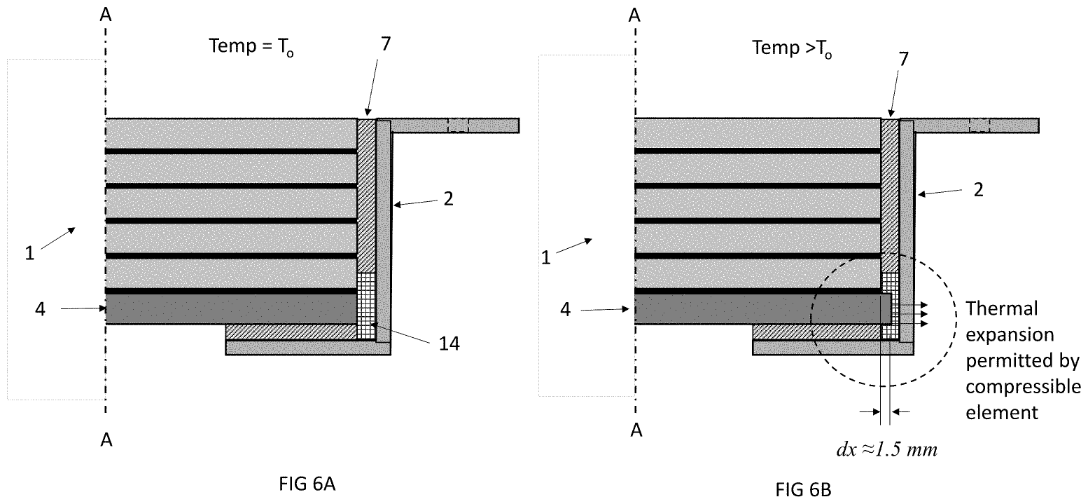

FIG. 6A-B demonstrate that a highly compressible element 14 when inserted into the potting material 7 between the TA 1 and the frame 2 avoid the development of compressive loads at the edge of the transparent backing layer 4 due to thermal expansion (FIG. 6B). The compressible element 14 is fully encapsulated by conventional potting adhesive-sealant to retain needed strength and to prevent penetration of water or water vapor.

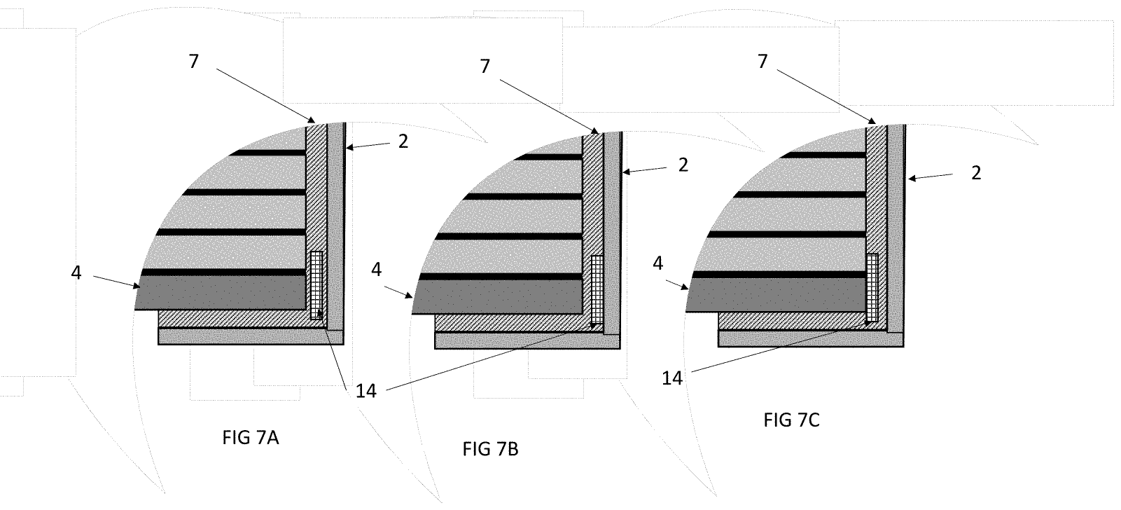

Several options exist for the sizing and location of the compressive element 14. The compressive element may be similar in thickness to the potting gap, or it may be somewhat thinner provided the overall maximum compressive and thickness of the element are sufficient for the anticipated expansion of the adjacent TA layer. If a thinner compressive element is utilized, it may be affixed to either the laminate edge 4 (FIG. 7C), the frame 2 (FIG. 7B), or allowed to float freely prior to introduction of the potting material 7 (FIG. 7A). In order to insure the compressive element remains properly located, fixing the element to either frame or laminate is preferred.

The compressive element within the potting gap can be almost any size that provides full coverage of the high expansion plastic transparent backing layer edges and retains sufficient bonding strength for the laminate within its frame. The compressive element may wrap the corner of the laminate and provide cushion on two sides of the plastic transparent backing layer. It is most important that the compressive element be positioned in the path of greatest thermal expansion. Any variation of placement and size of the compressive element is within the scope of the invention.

Suitable materials for use as a compressive element include silicone rubber, PVC, EPDM, urethane, neoprene, natural rubber, ionomer, polyethylene, nylon, fluoro-elastomer (Viton®), polyamine (Nylon®), thermoplastic vulcanization (Santoprene®), or any similar material of a closed cell foam-like structure that offers compressive and tensile elasticity while also chemically compatible with the selected potting materials and suitable for use in a temperature range from approximately −30° C. to +60° C. with temporary exposure to temperatures as low as −60° C. and as high as +90° C. or, any material that provides the necessary resilience and compliance. The cellular structure of the compressive element can be open or closed cell, however closed cell structures are preferred to avoid the risk of moisture collection within the compressive element. Compressive element material should be selected with consideration of chemical compatibility with potting materials and materials of TA construction as well as the expected range of service temperature. Commercially common foam strip materials with pressure sensitive adhesive applied to one side allows convenient attachment of the compressive element to the edge of the laminate or frame prior to mounting the TA within its frame and introduction of the potting material.

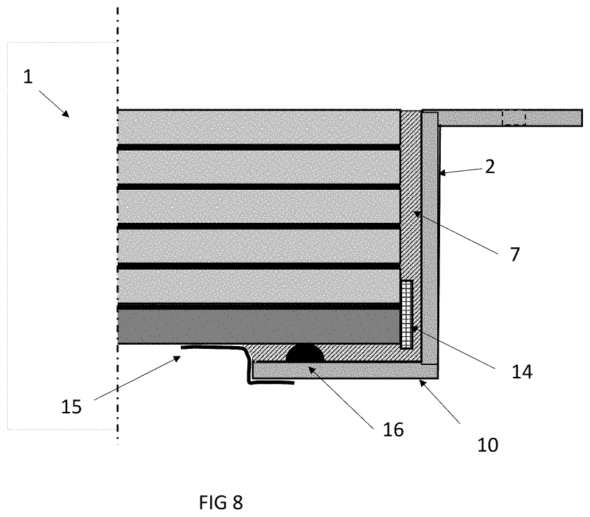

A preferred aspect (FIG. 8) can be achieved through the following simplified manufacturing steps: position self-adhesive spacers 16 on first (inner) frame flange 10 to preserve desired flange seal thickness; apply self-adhesive compressive strip material 14 around periphery of TA laminate providing full coverage of the high expansion transparent backing layers; mount TA laminate 1 in frame 2, allowing the TA to rest on spacers 16; seal gap between TA laminate and edge of frame flange 3 with suitable sealing tape 15; fill potting gap with selected potting material 7 to assure full penetration without trapped air pockets. An apparatus that provides a small tilting angle is useful to assist air removal during filling with a flowable potting material 7. Typically, the sealing tape 15 is temporary and placed on the TA/housing junction prior to addition of the potting and compressive material and removed after the potting material has cured.

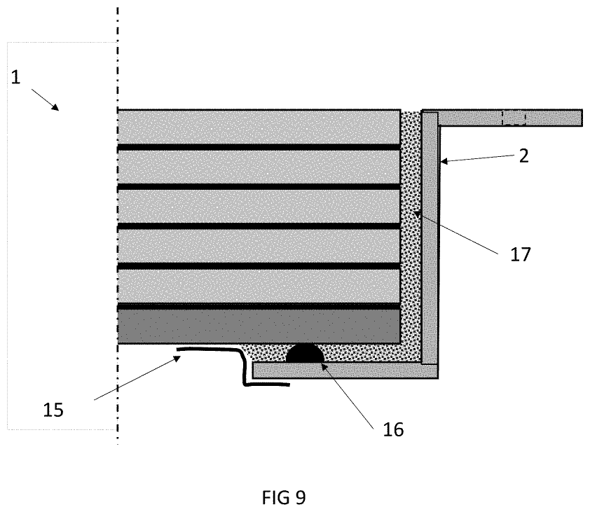

As an alternative, the potting material and compressive element are mixed to provide a new type of potting material 17 that provides a self-foaming characteristic during cure. Such a material must form a closed cell structure so that water is not admitted, and must retain sufficient strength to meet requirements for retention of the laminate in its frame. Urethane materials with blowing agent modifications can provide the desired characteristics (FIG. 9). FIG. 9 depicts yet another alternative where a corner is added to the gap between the TA and the outer edge of the first (inner) flange of the housing.

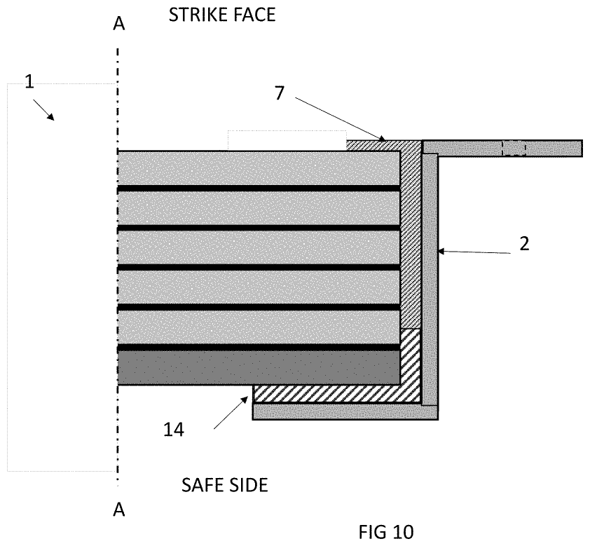

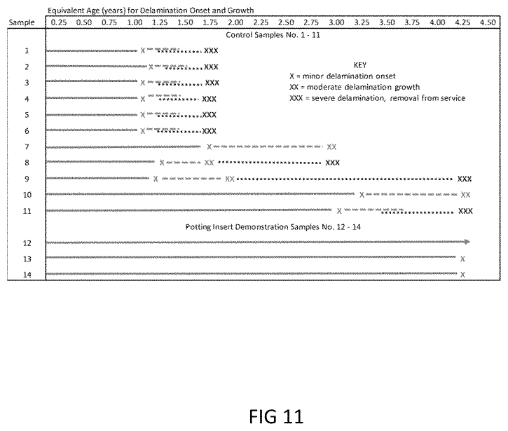

FIG. 10 depicts yet another aspect where two variations are fully shown and described. Compressive material is shown as filling the potting gap and covering the plastic backing layer on two sides. In yet another aspect, the TA is of a smaller height than the frame. In this case, the potting material not only fills the potting gap between the TA and the housing but also be place on the surface of the TA. The potting material may be transparent. As shown in FIG. 11, the glass layers of the TA would form the strike face of the TA and the plastic backing layer would represent the safe side.

### EXAMPLES

To demonstrate the efficacy of the invention, an accelerated environmental aging test was performed in an environment simulation chamber that is capable of producing rapid changes in temperature and humidity, which are carried out though multiple cycles to represent the daily extremes of environment on a compressed time scale.

The combination of rapid cycling between hot, cold, and high humidity (diurnal acceleration) with the use of extreme yet physically relevant values of hot, cold and humidity (aggravation) produces an overall testing cycle that allows the simulation of approximately one year of real-world aging in only 15 to 18 chamber test days (depending on the thickness and thermal response of the samples under test).

The transparent armor selected for demonstration testing was the standard armored windshield employed on the M1151 HMMWV military tactical vehicle. A total of 14 windshields were subjected to accelerated aging testing. Each windshield was potted in a standard aluminum frame as used in production of M1151 windshields. Eleven of these, numbered 1-11 in FIG. 11, served as control samples to establish baseline performance for standard window potting. To demonstrate the effectiveness of the potting insert invention, three additional samples, numbered 12-14 in FIG. 11, were potted with the addition of compressible insert technology according to FIG. 7A.

FIG. 11 provides a time-line for observance of delamination in the sample windows. An “X” denotes the observed onset of minor delamination. “XX” denotes an observation of delamination growth where total delamination is beginning to involve a significant portion of the window but the window would likely be retained in service. “XXX” denotes an observation of significant delamination which would typically result in the window being removed from service.

Review of FIG. 11 shows that, on average, standard windows begin to show signs of minor delamination within 1.6 years and become delaminated to a severe extent between 1.7 and 4.2 years. In comparison, windows that incorporate compressive-mitigating potting inserts endured accelerated aging for 4.2 or more equivalent years before delamination onset. One of the three demonstration samples (No. 12) showed no signs of delamination at conclusion of testing.

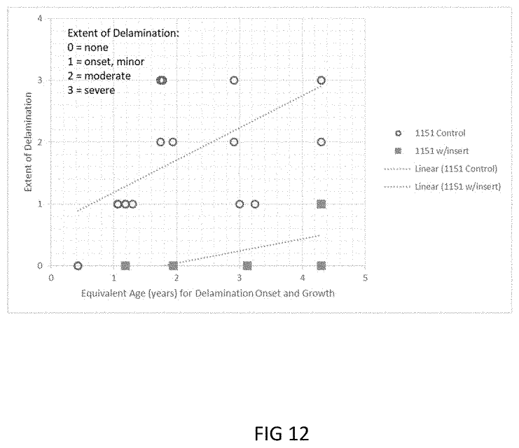

FIG. 12 demonstrates a plot of delamination extent vs. time that shows that control window samples can be expected to last up to three years before delamination becomes severe while windows that are potted with a compressive absorbing insert do not show any delamination in three years. FIG. 12 provides another visualization of the window endurance data portrayed as an X-Y plot of delamination onset and severity vs. time. The Y-axis value of “0” indicates that no delamination was observed at that time. Similarly, Y-axis values of 1, 2, and 3 denote increasing severity of delamination from onset (minor) through removal from service (severe).

According to FIG. 11, delamination in control samples grows from minor (at onset) to severe within approximately one to three years of equivalent life. With an average delamination onset of 1.6 years, a total service life of 2.6 to 4.6 years is indicated for M1151 windshields with standard frames and potting. This estimate matches well with real-world observations. If the standard window delamination growth rate is applied to windshields potted with the compressive insert, then a life expectancy of 5.3 to 8.3 years is indicated for M1151 windshields potted with compressive absorbing inserts.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When “only A or B but not both” is intended, then the term “only A or B but not both” will be employed. Thus, use of the term “or” herein is the inclusive, and not the exclusive use. As used in the specification and the claims, the singular forms “a,” “an,” and “the” include the plural. Finally, where the term “about” is used in conjunction with a number, it is intended to include ±10% of the number. For example, “about 10” may mean from 9 to 11.

The phrase first and second with respect to more than one flange described herein as well as the terms inner and outer, or interior and exterior, are simply applied to describe two flanges relative to each other, e.g. one located near the exterior of the product while one is found interiorly or a first flange may be added to the product first, to be followed by a second flange used for a second purpose.

The term TA, TA laminate, or transparent armor refers to the entire glass, the transparent backing layer and transparent adhesive between each layer of glass and/or transparent backing assembly. The term “glass” refers to any transparent material with a CTE like glass, or ceramized glass, or transparent ceramic. The term “backing” or “plastic” refers to any transparent material usable as a plastic transparent material in TA laminates. The term compressive element and compressive element both refer to a material able to change form in response to expansion and contraction of the backing and thereby relieve stress on the laminate structure and the potting material and the combination thereof. The term “comprising” is used throughout in describing the product and methods of making a TA/frame assembly. The product and method may also be described as “consisting essentially of” or “consisting of” those method steps and those elements cited.

As stated above, while the present application has been illustrated by the description of aspects, and while the aspects have been described in considerable detail, it is not the intention to restrict or in any way limit the scope of the appended claims to such detail. Additional advantages and modifications will readily appear to those skilled in the art, having the benefit of this application. Therefore, the application, in its broader aspects, is not limited to the specific details and illustrative examples shown. Departures may be made from such details and examples without departing from the spirit or scope of the general inventive concept.

1. A product comprising:
a compressive element;
a high flow adhesive-sealant elastomeric material;
a frame having an first frame flange, a second frame flange, means for mechanical attachment of the housing to a secondary structure on the second frame flange; and
a multilayer transparent armor (TA) laminate, the frame and TA laminate being about the same depth, the frame being larger than the TA in length and width thereby defining a potting gap between the interior of the frame and the outer edges of the TA when the TA is disposed inside the frame.

2. The product of claim 1, the compressive element is a material selected from the group consisting of: silicone rubber, polyvinyl chloride (PVC), ethylene propylene diene monomer (EPDM), urethane, neoprene, natural rubber, ionomer, polyethylene, nylon, a fluro-elastomer (FKM) polymer, a synthetic rubber, a fluoropolymer, a long-chain fiber-forming polyamide, a synthetic polymer of an aliphatic or semi-aromatic polyamine, a thermoplastic vulcanizate (TPV) and thermoplastic elastomer (TPE).

3. The product of claim 1, the compressive element having a length of at least the size of a transparent material layer of the TA and the compressive element being identical in width to the potting gap or less than the potting gap.

4. The product of claim 1, wherein the adhesive-sealant elastomeric material and compressive material being a homogeneous mixture or alternatively wherein the adhesive-sealant elastomeric material being a two component reaction cured urethane containing no solvents.

5. The product of claim 1, having a cured property of between about 35 to about 90 on the Shore A scale and a Poisson's Ratio between 0.47 and 0.5.

6. The product of claim 1, the multilayer transparent armor (TA) laminate comprised of:
at least one layer of glass, ceramized glass, or transparent ceramic;
at least one or more transparent backing layer of transparent material; and
transparent adhesive joining the layers to each other,
wherein the transparent materials is polycarbonate or poly(methyl methacrylate), and
wherein the transparent adhesive is polyvinyl butyral, thermoplastic polyurethane, or ethylene-vinyl acetate.

7. The product of claim 1, the coefficients of thermal expansions of the glass and the transparent backing layer material differing from each other by a factor of about 10 or more.

8. The product of claim 1 further comprising a spacer secured to the first frame flange of the housing upon which the multilayer transparent armor (TA) laminate rests.

9. The product of claim 1 the potting gap being between about 1 millimeter and about 20 millimeters.

10. A method of making framed Transparent Armor (TA) comprising:
providing a housing frame having an first frame flange, an external frame flange, means for mechanical attachment of the housing to a secondary structure on the external frame flange;
providing a multilayer transparent armor (TA) laminate, the housing and TA laminate being about the same depth, the housing being larger than the TA in length and width thereby defining a potting gap between the interior of the frame and the outer edges of the TA;
placing spacers on the first frame flange that will contact the TA;
adding a compressive element;
placing the TA within the frame and directly upon the spacers;
sealing the junction between the TA laminate and the first frame flange;
applying a potting product to the potting gap.

11. The method of claim 10, the compressive element or spacer further comprising means of securing the spacer or compressive material to either the frame or TA laminate.

12. The method of claim 10, the compressive element being secured to the interior of the frame at a position aligned with a transparent material layer of the TA laminate.

13. The method of claim 10, the compressive material applied around the entire outer edge of the TA laminate corresponding to a transparent material layer.

14. The method of claim 13, the compressive element being secured to the TA laminate in the path of greatest thermal expansion of the transparent material layer.

15. The method of claim 10, the compressive element placed in the potting gap between the frame and TA and surrounded by potting material.

16. The method of claim 10, the thickness of the compressive element being identical to the potting gap or less than the potting gap.

17. The method of claim 10, the compressive element is a material selected from the group consisting of: silicone rubber, polyvinyl chloride (PVC), ethylene propylene diene monomer (EPDM), urethane, neoprene, natural rubber, ionomer, polyethylene, nylon, a fluoro-elastomer (FKM) polymer, a synthetic rubber, a fluoropolymer, a long-chain fiber-forming polyamide, a synthetic polymer of an aliphatic or semi-aromatic polyamine, a thermoplastic vulcanizate (TPV) and thermoplastic elastomer (TPE).

18. The method of claim 10, the potting product having a cured property of between 35 to 90 on the Shore A scale and a Poisson's Ratio between 0.47 and 0.5.

19. The method of claim 10, the frame being steel, aluminum or a fiber composite material.

20. The method of claim 15, the multilayer transparent armor (TA) laminate comprised of:
at least one layer of glass, ceramized glass, or transparent ceramic;
at least one or more transparent backing layer of transparent material; and
transparent adhesive joining the layers to each other,
wherein the transparent materials is polycarbonate or poly(methyl methacrylate), and
wherein the transparent adhesive is polyvinyl butyral, thermoplastic polyurethane, or ethylene-vinyl acetate.
